(19) United States
(12) Patent Application Publication
(10) Pub. No.: US 2007/0096651 A1
(43) Pub. Date: May 3, 2007

(54) Plasma display panel

(75) Inventors: Noriaki Setoguchi, Higashimorokata-gun (JP); Koji Ohira, Higashimorokata-gun (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Higashimorokata (JP)

(21) Appl. No.: 11/584,496

(22) Filed: Oct. 23, 2006

(30) Foreign Application Priority Data
Oct. 27, 2005 (JP) 2005-313352

(51) Int. Cl. H01J 17/49

(52) U.S. Cl. 313/582; 313/583

(57) ABSTRACT

A plasma display panel is provided which achieves the reduction in discharge current and the improvement in luminance. The plasma display panel includes a pair of substrates opposite to each other, a discharge gas sealed between the substrates, and a plurality of first display electrodes and a plurality of second display electrodes disposed on one of the substrates to generate surface discharge. Each of the first and second display electrodes has a shape including an elongated strip portion extending over plural cells and a plurality of projections protruding from the strip portion in each of the cells. The projection of the first display electrode and the projection of the second display electrode define a surface discharge gap in each of the cells, and each of the projections of the first and second display electrodes is formed to have a serpentine strip shape having at least two bending portions.

### BACKGROUND OF THE INVENTION

1. Field of the Invention

The present invention relates to a surface discharge type plasma display panel. More particularly, the present invention relates to improvement in a display electrode for generating surface discharge.

2. Description of the Related Art

The surface discharge type plasma display panel includes row electrodes that are arranged as display electrodes for generating surface discharge, a dielectric layer for covering the row electrodes, column electrodes intersecting the display electrodes, partitions that are discharge barriers between cells and fluorescent materials for reproducing colors. A screen is made up of a plurality of cells (display elements) arranged in a matrix form.

In general, the row electrodes and the dielectric layer are disposed on a front substrate, while the column electrodes, the partitions and the fluorescent materials are disposed on a rear substrate. In terms of the increase in luminance, a reflection type in which the fluorescent materials are disposed on the rear substrate has an advantage over a transmission type in which they are disposed on the front substrate.

A row electrode array comes in two types. Herein, one is referred to as an independent type and the other is referred to as a common type for descriptive purposes. The independent type is an array type in which a pair of the row electrodes is disposed for each row of a matrix display. The total number of row electrodes is twice as many as the number of rows (vertical resolution). The common type is an array type in which the row electrodes whose total number is the number of rows plus one are disposed at regular intervals. In the common type, each of the row electrodes and each of the neighboring row electrodes make a display electrode pair for surface discharge and surface discharge gaps are formed at all gaps between the row electrodes. The independent type has the advantage of easy drive control, while the common type has the advantage of high utilization rate of a screen.

With a general panel structure in which the row electrodes are disposed on the front substrate as described above, the row electrodes include a transparent conductive film and a metal film in both the independent type and the common type. The transparent conductive film serves to secure an electrode area necessary to spread surface discharge appropriately. The metal film serves to compensate for conductivity of the transparent conductive film.

The most basic shape of the row electrode is a strip shape that directly extends over the entire length of a row and has a constant width. This strip shape is simple and is patterned relatively easily. The shape, however, has the disadvantage that a large discharge current is apt to flow.

The flow of the large discharge current involves an expensive driving circuit with a proper current capacity and also increases power consumption. Further, the flow of the large concentrated discharge current for a short time drops a driving voltage substantially, which causes an uneven display including intensity disturbance called streaking.

There are various proposals regarding a row electrode in such a surface discharge type plasma display panel. Japanese patent No. 3,352,821 describes that a row electrode is patterned to have a shape including a strip portion extending over plural cells and a plurality of projections protruding from the strip portion in each of the cells and thereby a discharge current is suppressed. Japanese patent No. 2,734,405 describes that a row electrode is patterned to have a ladder shape including a plurality of long strips parallel to one another and short strips for coupling the log strips to one another at regular intervals and thereby current concentration is reduced.

The conventional improvement is directed to reduce the area of the row electrode in the cell. Accordingly, an attempt to sufficiently suppress a discharge current limits the spread of surface discharge excessively, which makes it impossible to obtain sufficient luminance.

### SUMMARY OF THE INVENTION

The present invention is directed to solve the problems pointed out above, and therefore, a first object of the present invention is to suppress a discharge current and to improve luminance. A second object of the present invention is to reduce the number of man-hours and the number of materials upon the formation of electrodes.

According to one aspect of the present invention, a plasma display panel for achieving the first object includes a pair of substrates disposed in face-to-face relation with each other, a discharge gas sealed between the substrates, and a plurality of first display electrodes and a plurality of second display electrodes disposed on one of the substrates to generate surface discharge, each of the first and second display electrodes having a shape including an elongated strip portion extending over plural cells and a plurality of projections protruding from the strip portion in each of the cells, the projection of the first display electrode and the projection of the second display electrode defining a surface discharge gap in each of the cells. Each of the projections of the first and second display electrodes is formed to have a serpentine strip shape having at least two bending portions.

The projection is made in the form of a serpentine strip, increasing electrical resistance of a current path between the strip portion and the surface discharge gap. When discharge is generated at the surface discharge gap, a current flowing from the strip portion to the surface discharge gap is suppressed by the electrical resistance. A sufficient current is supplied, through the strip portion, from a power source to ends of the respective projections on the strip portion side. Since a voltage drop is substantial across the projection, surface discharge spreads toward the strip portion. Thereby, a discharge area extends, resulting in the high luminance.

According to another aspect of the present invention, a plasma display panel for achieving the second object includes, in addition to the feature descried above, a feature that the first and second display electrodes are metal electrodes. In the present invention, the selection of pattern dimensions of the projection can increase electrical resistance only in the projection of the display electrode. Accordingly, even if the strip portion and the projection are made of metal that is a good conductor, a discharge current can be suppressed.

According to yet another aspect of the present invention, a plasma display panel includes a feature that the cells are made up of three kinds of the cells having different light emission colors and the projections in any of the three kinds of the cells have a length different from that of at least one of the other cells. In this plasma display panel, the selection of the projection length can compensate for the slight difference among the cells in discharge characteristics to synchronize discharge timing of the three kinds of the cells, leading to the enhancement of color reproducibility. Conversely, the discharge timing in the cells can be made to be different from one another actively.

These and other characteristics and objects of the present invention will become more apparent by the following descriptions of preferred embodiments with reference to drawings.

### BRIEF DESCRIPTION OF THE DRAWINGS

FIG. 1 is an exploded perspective view showing a structure of a plasma display panel according to a first embodiment of the present invention.

FIG. 2 is a plan view showing a color array in a screen.

FIG. 3 is a plan view showing an outline of a row electrode shape.

FIG. 4 is a schematic diagram of a projection of a row electrode.

FIG. 5 is a plan view showing a first modification of a layered structure of the row electrode.

FIG. 6 is a plan view showing a row electrode shape in a plasma display panel according to a second embodiment of the present invention.

FIG. 7 is a plan view showing a second modification of the layered structure of the row electrode.

FIG. 8 is a plan view showing another example of a row electrode array.

### DESCRIPTION OF THE PREFERRED EMBODIMENTS

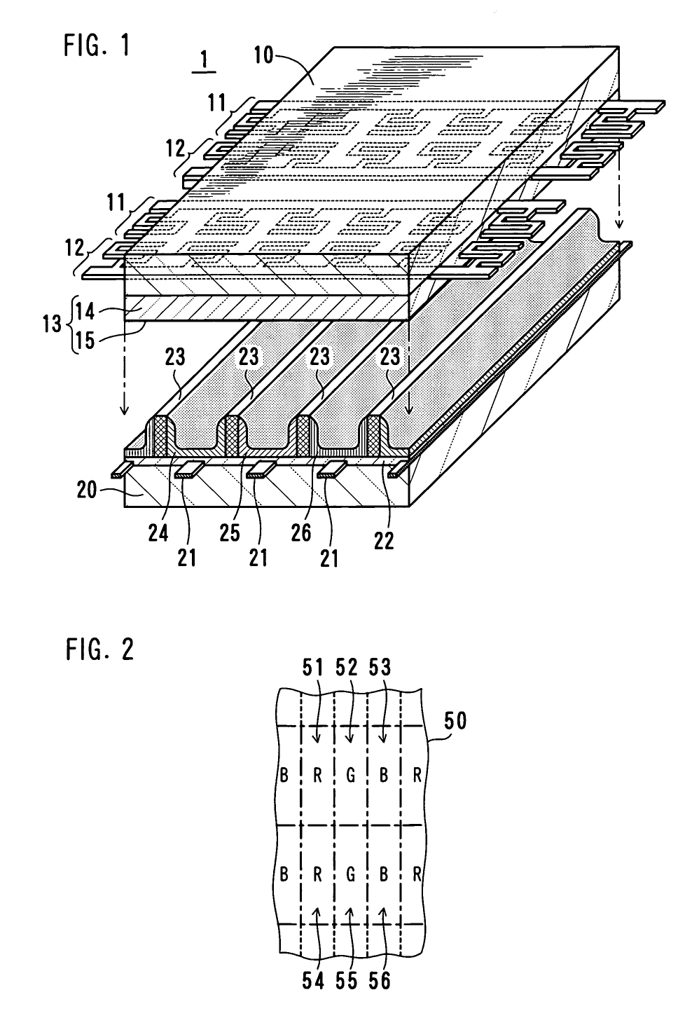

FIG. 1 is an exploded perspective view showing a structure of a plasma display panel according to a first embodiment of the present invention, and FIG. 2 is a plan view showing a color array in a screen. FIG. 1 shows a portion corresponding to six cells in the plasma display panel 1, i.e., cells 51, 52, 53, 54, 55 and 56 in the screen 50 shown in FIG. 2.

The plasma display panel 1 includes a front glass substrate 10, a rear glass substrate 20 and a discharge gas (not shown) sealed in a space between the substrates 10 and 20.

First row electrodes 11 and second row electrodes 12 both of which having a shape unique to the present invention are disposed on an inner surface of the glass substrate 10 as display electrodes for generating surface discharge. The row electrode 11 and the row electrode 12 make an electrode pair in each row. The electrodes 11 and 12 are covered by an insulation layer 13. The insulation layer 13 is a layered film including a dielectric layer 14 and a thin protection film 15.

Column electrodes 21 are disposed on an inner surface of the glass substrate 20 and are covered by a dielectric layer 22. A plurality of partitions 23 having a strip shape when viewed from the top is disposed, in parallel with one another, on the dielectric layer 22. The partitions 23 extend in the same direction as the column electrodes 21. The illustrated partition pattern is a striped pattern. The partitions 23 abut on the protection film 15 practically although they are spaced away from each other in the illustrated example.

A red (R) fluorescent material layer 24, a green (G) fluorescent material layer 25 or a blue (B) fluorescent material layer 26 is formed between the adjacent partitions 23. The fluorescent material layers 24, 25 and 26 have a continuous strip shape extending over the plural cells arranged along the partitions 23.

As shown in FIG. 2, the screen 50 is made up of many cells arranged in rows and columns. FIG. 2 shows a part of a row including the three cells 51, 52 and 53 and a part of a row including the three cells 54, 55 and 56. The color array in the screen 50 is a striped array in which the cells belonging to each column have the same light emission color and each column has a light emission color different from those of the neighboring columns. Three cells arranged along the horizontal direction correspond to one pixel.

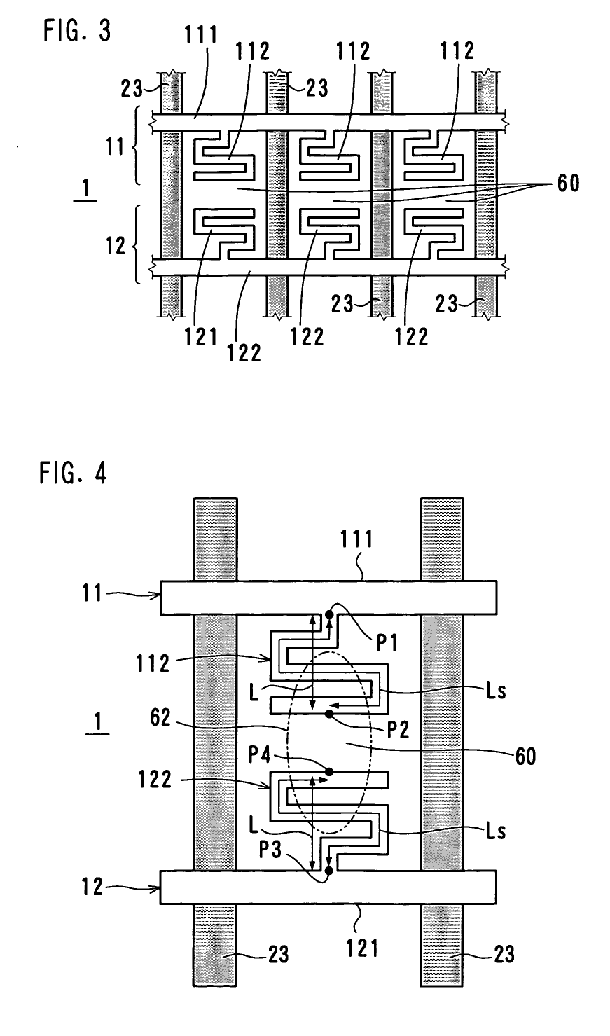

FIG. 3 is a plan view showing an outline of the row electrode shape, and FIG. 4 is a schematic diagram of a projection of the row electrode.

In this example, the entire row electrode 11 and the entire row electrode 12 are metal electrodes made of a metal thin film that is patterned using photolithography. More specifically, each of the electrodes 11 and 12 is a layered film including a base layer made of chromium (Cr) having a thickness of approximately 50 nm, a main conductor layer made of copper (Cu) having a thickness of approximately 3 μm and an upper layer made of chromium having a thickness of approximately 50 nm. Note that the materials for the electrodes and the film thickness are not limited to this example. Other metal such as aluminum, nickel, silver or gold can be used as the materials. Any other metal can be used as the materials for the electrodes, as long as they can provide sufficient conductivity even if they are arranged on a large screen with a diagonal of 50 inches or greater.

As shown in FIG. 3, the row electrode 11 is patterned to have a shape including a strip portion 111 and a plurality of projections 112. The strip portion 111 extends over the cells arranged in the row direction and has a constant width. Each of the projections 112 protrudes from the strip portion 111 in the cell toward the row electrode 12 with which the row electrode 11 makes a pair. Likewise, the row electrode 12 is patterned to have a shape including a strip portion 121 and a plurality of projections 122. The strip portion 121 extends over the cells arranged in the row direction and has a constant width. Each of the projections 122 protrudes from the strip portion 121 in the cell toward the row electrode 11 with which the row electrode 12 makes a pair. In each of the cells, the projection 112 of the row electrode 11 and the projection 122 of the row electrode 12 form a surface discharge gap 60 (a gap between the display electrodes).

As shown in FIG. 4, the projection 112 of the row electrode 11 is patterned in the form of one strip that meanders and has five bending portions. The end of the projection 112 extends in parallel with the strip portion 111. Likewise, the projection 122 of the row electrode 12 also has one serpentine strip shape with five bending portions. The projection 112 of the row electrode 11 and the projection 122 of the row electrode 12 are disposed symmetrically with respect to the center position of the cell in the row direction and in the column direction. This is because surface discharge 62 is initiated at the center of the cell in the row direction. The connection point P1 between the projection 112 and the strip portion 111 and the connection point P3 between the projection 122 and the strip portion 121 lie at the center in the row direction of the cell.

In the projection 112 of the row electrode 11, a current path between the connection point P1 and a discharge initiation point P2 has a length Ls greater than a linear distance L between the connection point P1 and the discharge initiation point P2. For the purpose of increasing electrical resistance deliberately, the length Ls is preferably set to be twice or more the linear distance L. In order to increase the length Ls without narrowing the surface discharge gap 60, it is preferable that a pattern width of the strip portion constituting the projection 112 be reduced and the number of bending portions be increased. The reduction of the pattern width increases an electrical resistance value without changing the length Ls. Similarly, in the projection 122 of the row electrode 12, a current path between the connection point P3 and a discharge initiation point P4 has a length Ls greater than a linear distance L between the connection point P3 and the discharge initiation point P4.

With the plasma display panel 1 including the projections 112 and 122, the current path from each of the strip portions 111 and 121 to the surface discharge gap 60 has high electrical resistance. When the surface discharge 62 is generated, a discharge current flowing from each of the strip portions 111 and 121 to the surface discharge gap 60 is suppressed by the electrical resistance. Stated differently, the peak value of the discharge current is smaller than those of plasma display panels having conventional structures. Further, since voltage drops are substantial across the projections 112 and 122, the surface discharge 62 easily spreads through the projections 112 and 122. These operations can achieve the suppression of the discharge current and the improvement in luminance.

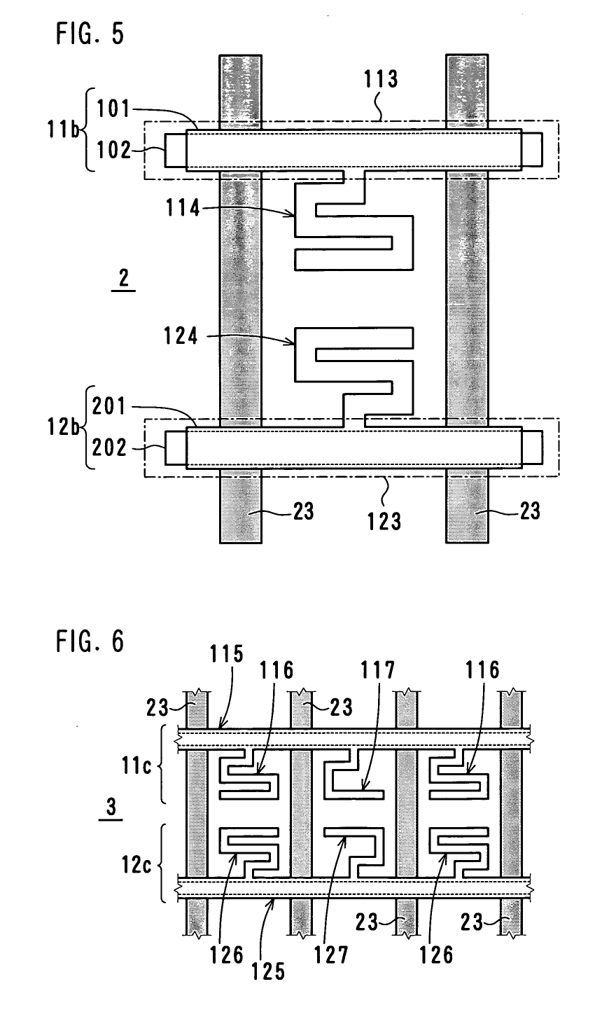

FIG. 5 is a plan view showing a first modification of the layered structure of the row electrode.

Referring to FIG. 5, the plasma display panel 2 includes a row electrode 11b that is a layered film having a transparent conductive film 101 and a metal film 102. In the row electrode 11b, a strip portion 113 extending over plural cells arranged in the row direction is made up of a part of the transparent conductive film 101 and the metal film 102 overlapping therewith. A projection 114 is the remaining part of the transparent conductive film 101 and is patterned to have a serpentine strip shape similar to that of the illustrated example of FIG. 3 or 4.

A row electrode 12b is a layered film including a transparent conductive film 201 and a metal film 202. In the row electrode 12b, a strip portion 123 extending over plural cells arranged in the row direction is made up of a part of the transparent conductive film 201 and the metal film 202 overlapping therewith. A projection 124 is the remaining part of the transparent conductive film 201 and is patterned to have a serpentine strip shape similar to that of the illustrated example of FIG. 3 or 4.

The transparent conductive films 101 and 201 have a resistance value per unit length that is higher than that of the metal films 102 and 202. Accordingly, compared to the case where the row electrodes 11b and 12b are made of metal, the row electrodes 11b and 12b can provide desired electrical resistance even if the projections 114 and 124 are formed to have a shorter length or a larger pattern width.

FIG. 6 is a plan view showing a row electrode shape in a plasma display panel according to a second embodiment of the present invention.

Referring to FIG. 6, a plasma display panel 3 has a cell structure and a screen structure that are basically the same as those of the first embodiment described above. The plasma display panel 3 differs from the plasma display panel of the first embodiment in row electrode shape.

As shown in FIG. 6, a row electrode 11c is patterned to have a shape including a strip portion 115 and a plurality of projections 116 and 117. The strip portion 115 extends over plural cells arranged in the row direction and has a constant width. The projections 116 and 117 protrude from the strip portion 115 toward a row electrode 12c with which the row electrode 11c makes a pair. Likewise, the row electrode 12c is patterned to have a shape including a strip portion 125 and a plurality of projections 126 and 127. The materials for the row electrodes 11c and 12c may be metal as shown in the example of FIG. 3 or 4. Alternatively, the materials for them may be composite materials in the form of layered film including the transparent conductive film and the metal film as shown in the example of FIG. 5. FIG. 6 shows a structure in which the strip portions 115 and 125 are made of a transparent conductive film and a metal film (shown by a broken line in the drawing) overlapping therewith.

The plasma display panel 3 is characterized in that the shapes of the projections 116, 117, 126 and 127 of the row electrodes 11c and 12c are selected for each cell. More specifically, among first, second and third cells arranged in the row direction, i.e., out of three kinds of the cells having different light emission colors, the projections 117 and 127 disposed in one kind of the cells has a length different from those of the projections 116 and 126 disposed in the other two kinds of the cells respectively. In the illustrated example, each of the projections 117 and 127 is a strip portion having three bending portions. The projections 117 and 127 are shorter than the projections 116 and 126 each of which has five bending portions. Stated differently, the projections 117 and 127 have electrical resistance lower than that of the projections 116 and 126.

The peak current value upon discharge changes depending on the electrical resistance as described above. Besides, a discharge delay time also changes depending on the electrical resistance. The increase in the electrical resistance increases the discharge delay time. Accordingly, the electrical resistance of the projections is selected for each cell, which makes it possible to reduce or increase the variations in the discharge delay time among the cells. In some cases, for example, the discharge delay time is different depending on the light emission color due to the differences of the fluorescent material. In such cases, the discharge delay times in the three kinds of the cells having different light emission colors are synchronized with one another. Thereby, no color shift of additive color mixing is present, leading to the enhancement of color reproducibility. Further, the variations in the discharge delay time are actively increased, which allows current concentration to be reduced.

In the example shown in FIG. 6, the projection shape is different between one kind of the cells and the other two kinds of the cells. Instead, however, the projection shape can be different for each kind of the cells. In the control of electrical resistance through the selection of a shape, which is unique to the present invention, fine control is easier and more secure compared to the control through the selection of materials.

As an application of the different projection length among the cells, the projection length in each of the cells may be selected depending on the cell position in the row direction. In the case, for example, where an application voltage difference is generated, by a voltage drop across the strip portion, between the end portions and the central portion of the row electrode in the row direction, the projection in the cell where the application voltage is relatively high is elongated to increase the electrical resistance, leading to the equalization of discharge intensity of the cells in one row.

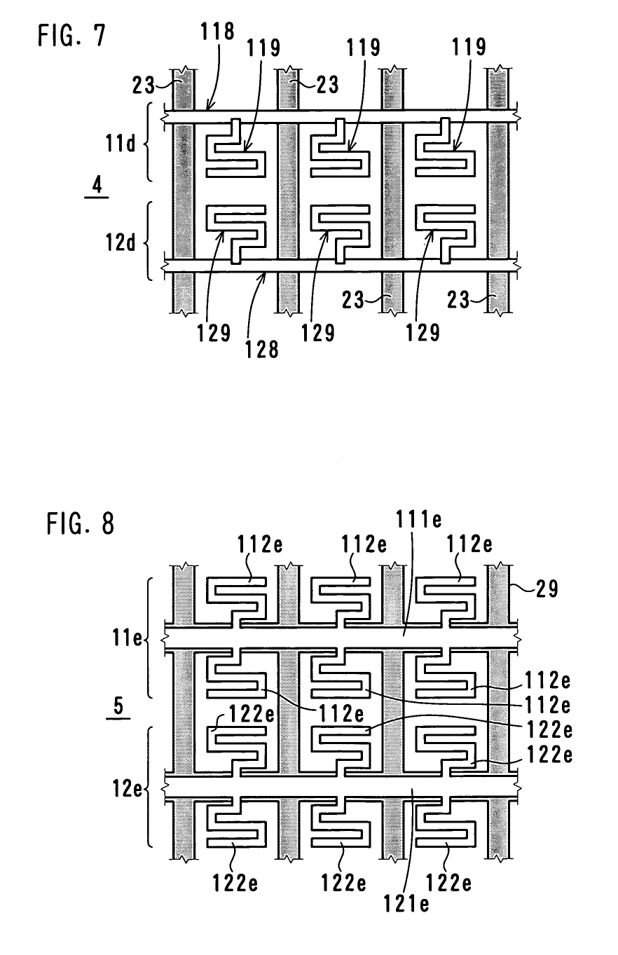

FIG. 7 is a plan view showing a second modification of the layered structure of the row electrode.

A plasma display panel 4 shown in FIG. 7 includes a row electrode 11d and a row electrode 12d. The row electrode 11d includes a strip portion 118 that is a metal film extending over plural cells arranged in the row direction. A projection 119 in each cell that protrudes from the strip portion 118 is a transparent conductive film. Likewise, the row electrode 12d includes a strip portion 128 that is a metal film and projections 129 each of which is a transparent conductive film.

FIG. 8 is a plan view showing another example of a row electrode array.

The present invention is applicable to a common type of row electrode array as shown in FIG. 8 in addition to an independent type of row electrode array.

A plasma display panel 5 shown in FIG. 8 includes a row electrode 11e, a row electrode 12e and a mesh-patterned partition 29 that delimits a screen vertically and horizontally. The row electrode 11e is patterned to have a shape including a strip portion 111e and a plurality of projections 112e. The strip portion 111e extends over plural cells arranged in the row direction and has a constant width. The projections 112e protrude from the both sides of the strip portion 111e. Likewise, the row electrode 12e is patterned to have a shape including a strip portion 121e and a plurality of projections 122e. The strip portion 121e extends over plural cells arranged in the row direction and has a constant width. The projections 122e protrude from the both sides of the strip portion 121e. In each of the cells, the projection 112e of the row electrode 11e and the projection 122e of the row electrode 12e form a surface discharge gap. The materials for the row electrodes 11e and 12e may be metal. Alternatively, the materials for them may be composite materials in the form of layered film including a transparent conductive film and a metal film. FIG. 8 shows an example of the row electrodes 11e and 12e as metal electrodes.

In the examples shown in FIGS. 3 and 5, all the strip portions (bus portions) and all the projections (discharge electrode portions) of the row electrodes are made up of a common metal conductor. According to the examples, an electrode forming process can be reduced compared to the case where the projections functioning as the discharge electrode portions are made up of a transparent conductive film. The present invention is beneficial to the case of using row electrodes that are entirely made of metal. The present invention makes it possible to sufficiently limit a discharge current in each of the cells due to the projections having multiple bending portions and to extract display light through clearances between the bending portions. Besides, in the case where the entire row electrode is patterned by a trilaminar metal film of Cr, Cu and Cr, as described earlier with reference to FIG. 3, some of the Cu film of the serpentine pattern of the projection can be cut to control resistance.

In the embodiments described above, the overall structure of the plasma display panel, the structures of various elements thereof, especially the structure of the row electrode as a display electrode may be changed as needed, in accordance with the subject matter of the present invention. The pattern dimensions of the row electrode may be selected depending on specifications of a cell size. The shape of the projection in the row electrode is not limited to the combination of lines bending at right angles and may include a curve. The bend includes a twist and a sinuosity. The strip making up the projection does not necessarily have a constant pattern width. The pattern width may be different between a part close to the strip portion and a part far therefrom.

The present invention enables the suppression of a discharge current and the improvement in luminance.

The present invention also enables the reduction in the number of man-hours and the number of materials upon the formation of electrodes.

Further, the present invention can reduce the variations in discharge delay among the cells having different light emission colors and can enhance color reproducibility.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A plasma display panel comprising:
a pair of substrates disposed in face-to-face relation with each other;
a discharge gas sealed between the substrates; and
a plurality of first display electrodes and a plurality of second display electrodes disposed on one of the substrates to generate surface discharge, each of the first and second display electrodes having a shape including an elongated strip portion extending over plural cells and a plurality of projections protruding from the strip portion in each of the cells, the projection of the first display electrode and the projection of the second display electrode defining a surface discharge gap in each of the cells,
wherein
each of the projections of the first and second display electrodes is formed to have a serpentine strip shape having at least two bending portions.

2. The plasma display panel according to claim 1, wherein the first and second display electrodes are metal electrodes.

3. The plasma display panel according to claim 1, wherein the cells are made up of three kinds of the cells having different light emission colors and the projections in any of the three kinds of the cells have a length different from that of at least one of the other cells.
